(19) United States
(12) Patent Application Publication
(10) Pub. No.: US 2012/0093611 A1
(43) Pub. Date: Apr. 19, 2012

(54) SLIP WASHER

(76) Inventor: Earl Wilson Knight, JR., Murrells Inlet, SC (US)

(21) Appl. No.: 13/275,384

(22) Filed: Oct. 18, 2011

Related U.S. Application Data
(60) Provisional application No. 61/394,212, filed on Oct. 18, 2010.

(51) Int. Cl. F16B 43/00; F16B 33/00

(52) U.S. Cl. 411/368; 411/371.2; 411/539

(57) ABSTRACT

The present invention relates to a slip washer comprising a flat metal disc having a center hole for placing around a bolt shaft and a cut channel allowing the washer to be installed without slipping it over the end of the shaft.

This application claims priority to U.S. provisional application No. 61/394,212 filed on Oct. 18, 2010 and is included herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to washers and nut/washer assemblies. In particular, the present invention relates to washers that can be used with bolt assemblies after they are in place with a nut or are in another threaded location.

2. Description of Related Art

The use of a washer with a bolt (either with a nut or screwed into a device) is well known. The washer helps lock the nut in place and can also spread the gripping force of the nut over a greater surface or act as a shim. Though washers are utilized for other purposes, their use on a nut shaft is very specific and usually washers designed for use with nuts only are specified in construction projects. One of the problems with the use of washers occurs when it is undesirable or impractical to remove the nut to thread the standard donut shaped washer over the shaft of the nut, for example, when replacing the washer during use.

The basic solution for placing a washer around the shaft of a bolt has been the use of washers that are multi-piece or must be bent, twisted, hinged, multi-thicknesses, or notched in order to be utilized as a washer. While these solve the problem, the solution weakens the washer and leads to early failure of the washer when used with a nut. While solutions to this problem go back 100 years, a simpler but effective bolt washer assembly is needed by the marketplace.

### BRIEF SUMMARY OF THE INVENTION

The present invention relates to the discovery that after 100 years the best solution to the above problem is a single piece flat channeled washer.

Accordingly, one embodiment of the present invention is a bolt assembly comprising a bolt having a select threaded shaft diameter that is threaded into place and a washer positioned around the bolt shaft consisting of a single piece of a flat metal of even thickness, the washer having a hole slightly bigger than the shaft diameter and a channel from an edge of the washer to an edge of the hole at least slightly bigger than the shaft diameter.

Another embodiment is a washer designed for positioning around a bolt shaft consisting of a single piece of a flat metal of even thickness, the washer having a hole slightly bigger than the shaft diameter and a channel from an edge of the washer to an edge of the hole at least slightly bigger than the shaft diameter.

### BRIEF DESCRIPTION OF THE DRAWINGS

FIG. 1 is a top view of an even channel washer.

FIG. 2 is a top view of a tapered channel washer.

FIG. 3 is a perspective view of an even channel washer.

FIG. 4 is a perspective view of the bolt washer assembly of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “about” means ±10 percent.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “bolt” refers to a device comprising a shaft, such as a metal rod or pin, for fastening objects together that has a head at one end and a screw thread at the other and is secured by a nut or a complimentary threaded portion in a device or object, for example, bolting the head onto an engine block where there are threads in the block for receiving the threaded shaft rather than passing the bolt through the device and securing it with a nut.

As used herein, the shaft of the bolt will as used herein will have a “shaft diameter”, that is the circumference around the shaft. This diameter is usually in metric or English inch units and the matching nut or reverse threading is a matching set of thread. The shaft is normally threaded into place in the nut or reverse threads. Standard or custom diameters can be utilized.

As used herein the term “washer” refers to the piece that fits around the shaft of the bolt between the head of the bolt and the item being bolted. Its use is for spreading out the pressure, tightening the fit, preventing leakage, and the like. In the present invention washer, the hole in the washer is designed to be bigger than the bolt shaft in order to fit around the shaft and not be so big that the head of the bolt does not touch and hold the washer in place. Such dimensions are within the skill in the art. The washer is usually equipped then with a round hole to accommodate the round shaft of a bolt. The washer has an outer diameter and one skilled of the art would choose an outer diameter (the “edge” of the washer to be large enough to accommodate the hole and fit into place and do the selected job). Typically washers are round but can be any shape that accomplishes the job including rectangular or oval. The washer is a flat material that is a single thickness and manufactured of an appropriate metal such as steel or aluminum and their alloys.

While numerous types of washers have been known for more than a century, the washer of the present invention consists of a channel between the outer edge of the washer and the hole as shown in the figures. This open construction allows for placing the washer on the shaft of a bolt while it is either engaged with a nut or screwed into some other threaded device. This can be clearly seen in the drawings. One using the washer would place the washer around the shaft so that the hole is positioned around the shaft and tightened the bolt such that the head firmly engages the washer of the present invention, thus holding it in place. The channel can have parallel or tapering sides (with no more than 30 percent difference in width top to bottom) such that the channel is either of even width or a tapered width.

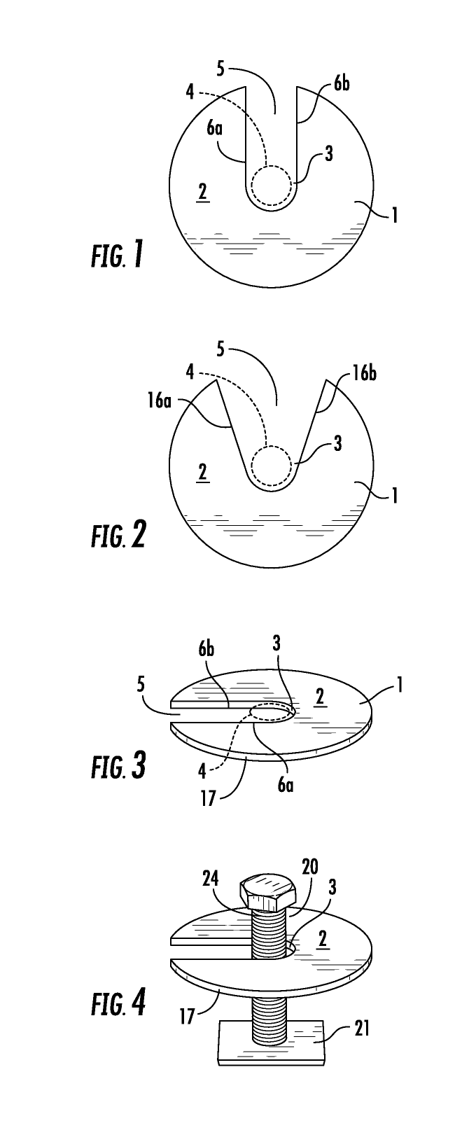

Now referring to the drawings. FIG. 1 is a top view of a washer of the present invention. Washer 1 comprises the body portion 2 with center hole 3. The circumference of a bolt shaft 4 is shown in dotted line. The channel 5 is shown with parallel sides 6a and 6b.

FIG. 2 is a top view of a different embodiment of the present invention wherein the sides 16a and 16b of channel 5 are not parallel.

In FIG. 3 one can view a perspective of the washer in FIG. 1. In this view, washer 1 can be seen to be of even thickness 17 across the entire body 2 and flat.

In FIG. 4 there is depicted a perspective view of the bolt and washer assembly. In this embodiment, bolt 20 is attached to receiver 21 which can be a nut or any other device or object with reverse threading. The threaded shaft 24 of bolt 20 is positioned in the hole 3 of washer 1 after channel 5 has been utilized to slip the washer 1 over the shaft 24 since the shaft 24 is in reverse threaded device receiver 21 and cannot be placed over the tip of the bolt (which is not shown).

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A bolt assembly comprising a bolt having a select threaded shaft diameter that is threaded into place and a washer positioned around the bolt shaft consisting of a single piece of a flat metal of even thickness, the washer having a hole slightly bigger than the shaft diameter and a channel from an edge of the washer to an edge of the hole at least slightly bigger than the shaft diameter.

2. The assembly according to claim 1 wherein the channel is of even width.

3. The assembly according to claim 1 wherein the channel is of a tapered width.

4. The assembly according to claim 1 wherein the metal is an inflexible metallic material.

5. The assembly according to claim 1 wherein the washer has an outer round circumference.

6. The assembly according to claim 1 wherein the washer is made of a metal selected from steel and aluminum.

7. The assembly according to claim 1 wherein the bolt is threaded into place with a nut.

8. The assembly according to claim 1 wherein the bolt is threaded into a device having reverse bolt threads.

9. A washer designed for positioning around a bolt shaft consisting of a single piece of a flat metal of even thickness, the washer having a hole slightly bigger than the shaft diameter and a channel from an edge of the washer to an edge of the hole at least slightly bigger than the shaft diameter.
